(19) United States
(12) Patent Application Publication
(10) Pub. No.: US 2009/0126543 A1
(43) Pub. Date: May 21, 2009

(54) System and method for supplying processing water

(75) Inventors: Yasuyuki Kitagawa, Kyoto-shi (JP); Shuzo Yamaji, Hirakata-shi (JP); Takaaki Hibi, Kyoto-shi (JP); Kana Tomizawa, Kyoto-shi (JP)

Correspondence Address: OLIFF & BERRIDGE, PLC, P.O. BOX 320850, ALEXANDRIA, VA, 22320-4850, US

(73) Assignee: TOWA CORPORATION, KYOTO-SHI (JP)

(21) Appl. No.: 12/289,845

(22) Filed: Nov. 5, 2008

(30) Foreign Application Priority Data
Nov. 21, 2007 (JP) 2007-301095

(51) Int. Cl. B24C 9/00; B01D 33/00

(52) U.S. Cl. 83/53; 83/177

(57) ABSTRACT

The present invention provides a system 1A for supplying processing water 3, which is used in the operation of processing a target object with a highly pressurized jet of processing water 3 containing an abrasive, including: a tank 2 for storing the processing water 3, having a lower portion substantially tapering downwards; a supply pipe 5 for supplying the processing water 3 to the tank 2; a delivery pipe 8 having an opening 9 located inside the tank 2; a pressure mechanism 7 located outside the tank 2, for pressurizing the processing water 3; and a suction port 10 provided in the side surface of the delivery pipe 8. The processing water 3 in the tank 2 is stratified into a deposition portion 4A, which is a portion where the abrasive is deposited, and a clear-water portion 4W, which is a portion other than the deposition portion 4A and formed by clear water substantially free from the abrasive. The opening 9 is located near an end of the delivery pipe 8 and at a position within the deposition portion 4A, while the suction port 10 is located at a position within the clear-water portion 4W.

### TECHNICAL FIELD

The present invention relates to a system and method for supplying processing water, which is used in the operation of processing a target object with a highly pressurized jet of processing water containing an abrasive.

### BACKGROUND ART

A conventional operation (such as a cutting, machining or polishing operation) using processing water containing an abrasive is hereinafter described. This operation is intended for processing a target object by strongly pressurizing water containing an abrasive and jetting the water onto the object. Such a system is called the abrasive suspension jet system (for example, refer to Non-Patent Document 1).

An example of the abrasive suspension jet system is hereinafter described (for details, refer to Patent Document 1). In this system, a slurry-mixed liquid, which consists of water and a slurry containing an abrasive (e.g. abrasive grains made of alumina), is stored in a cylindrical or prismatic storage tank. The storage tank has a pipe in its lower portion, through which the slurry-mixed liquid is supplied into a main tank. The slurry-mixed liquid in the main tank is stirred with an agitator. After the stirring operation, a spacer located inside the main tank is slid downwards to pressurize the stirred slurry-mixed liquid. The slurry-mixed liquid thus pressurized is pushed from the main tank into a pipe and powerfully jetted from a nozzle onto a target object (which is a substrate in the case of Patent Document 1), whereby the object is processed. The slurry-mixed liquid that has been used in this process is received by a cylindrical or prismatic catcher (or recovery tank) and returned to the storage tank by way of a pipe provided in the lower portion of the recovery tank and a clarifying filter (or sieve) for reuse.

The previously described conventional technique has the following problems. Firstly, the abrasive is deposited onto the inner bottom portion of each of the cylindrical or prismatic storage and recovery tanks, so that a deposition portion containing the abrasive with a high concentration is formed. This section, i.e. the lower portion (or deposition portion) of the tank, is where the pipe system for delivering the slurry-mixed liquid is connected to the tank. Therefore, the pipe system is liable to be clogged with the abrasive. Secondly, the clarifying filter is also likely to be clogged with the abrasive, chips or other materials. To deal with these problems, the system requires additional effort for the management and maintenance of the pipe system and clarifying filter.

Patent Document 1: Japanese Unexamined Patent Application Publication No. 2007-083362 (pp. 4-7 and FIG. 1)

Non-Patent Document 1: Munehiro Shuko et al., “Development of Water Jet Polishing Machine”, Study Report of Hiroshima Prefectural Technology Research Institute, Eastern Region Industrial Research Center, 15^{th} Issue (2002), Aug. 29, 2002, p. 31

### DISCLOSURE OF THE INVENTION

### Problems to be Solved by the Invention

Thus, the present invention intends to solve two problems. The first problem is that the pipe system for delivering processing water containing an abrasive from the tank is easy to be clogged with the abrasive. The second problem is that the sieve, which is used in the process of reusing the processing water that has been through the process, is easy to be clogged with the abrasive, chips or other materials.

### Means for Solving the Problems

The numerals in parenthesis used in the description of “MEANS FOR SOLVING THE PROBLEMS”, “EFFECTS OF THE INVENTION” and “BEST MODE FOR CARRYING OUT THE INVENTION” are intended for facilitating the comparison between the terms used in the description and the components shown in the drawings. The use of these numerals should never be understood to mean that “the meaning of the terms used in the description should be restricted to the components shown in the drawings.”

To solve the aforementioned problems, one aspect of the present invention provides a system (1A-1E) for supplying processing water (3), which is used in the operation of processing a target object with a highly pressurized jet of processing water (3) containing an abrasive, wherein the system includes: a tank (2 or 11) for storing the processing water (3), having a lower portion substantially tapering downwards; a supply pipe (5) for supplying the processing water (3) to the tank (2 or 11); a delivery pipe (8, 12, 14, 15 or 23) having an opening (9) located inside the tank (2 or 11); either a pressure mechanism (7) located outside the tank (2 or 11), for pressurizing the processing water (3), or a suction mechanism located outside the tank (2 or 11), for suctioning the processing water (3) through the delivery pipe (8, 12, 14, 15 or 23); and a suction port (10) provided in the side surface of the delivery pipe (8, 12, 14, 15 or 23). This system is further characterized in that: the processing water (3) in the tank (2 or 11) is stratified into a deposition portion (4A), which is a portion where the abrasive is deposited, and a clear-water portion (4W), which is a portion other than the deposition portion (4A) and formed by clear water substantially free from the abrasive; the opening (9) is located near an end of the delivery pipe (8, 12, 14, 15 or 23) and at a position within either one of the deposition portion (4A) or the clear-water portion (4W); and the suction port (10) is located at a position within the other one of the deposition portion (4A) and the clear-water portion (4W).

According to one mode of the present invention, the previously described system for supplying processing water is further characterized in that the area of the opening (9) is larger than the cross-sectional area of the delivery pipe (14 or 15).

Another aspect of the present invention provides a system for supplying processing water (3), which is used in the operation of processing a target object with a highly pressurized jet of processing water (3) containing an abrasive, wherein the system includes: a tank (2 or 11) for storing the processing water (3), having a lower portion substantially tapering downwards; a supply pipe (5) for supplying the processing water (3) to the tank (2 or 11); a delivery pipe (16 or 19) having an opening (17 or 20) located inside the tank (2 or 11); and either a pressure mechanism (7) located outside the tank (2 or 11), for pressurizing the processing water (3), or a suction mechanism located outside the tank (2 or 11), for suctioning the processing water (3) through the delivery pipe (16 or 19). This system is further characterized in that: the opening (17 or 20) is formed by cutting out a section that minimally corresponds to a portion of the side surface of the delivery pipe (16 or 19); the processing water (3) in the tank (2 or 11) is stratified into a deposition portion (4A), which is a portion where the abrasive is deposited, and a clear-water portion (4W), which is a portion other than the deposition portion (4A) and formed by clear water substantially free from the abrasive; and the opening (17 or 20) extends over the deposition portion (4A) and the clear-water portion (4W).

According to one mode of the present invention, any of the previously described systems for supplying processing water (3) further includes: a sieve mechanism located under the delivery pipe (5) and a clogging prevention mechanism (22 or 24) for preventing the clogging of the sieve mechanism (21), the clogging prevention mechanism (22, 24) including at least either a shaking mechanism (22) for shaking the sieve mechanism (21) or a bubble generation mechanism (24), located in the vicinity of the sieve mechanism (21), for generating bubbles (25) and for projecting the bubbles at the sieve mechanism (21).

Another aspect of the present invention provides a method for supplying processing water (3) in the operation of processing a target object with a highly pressurized jet of processing water (3) containing an abrasive, wherein the method includes the following steps: supplying the processing water (3) into a tank (2 or 11) having a lower portion substantially tapering downwards; stratifying the processing water (3) in the tank (2 or 11) into a deposition portion (4A), which is a portion where the abrasive is deposited, and a clear-water portion (4W), which is a portion other than the deposition portion (4A) and formed by clear water substantially free from the abrasive; and pressurizing or suctioning the processing water (3) so as to deliver the processing water (3) through a delivery pipe (8, 12, 14, 15 or 23) having an end located within the tank (2 or 11). The delivery pipe (8, 12, 14, 15 or 23) has an opening (9) provided near the end thereof and a suction port (10) provided in the side surface thereof. In the step of delivering the processing water (3), the opening (9) is located at a position within either one of the deposition portion (4A) or the clear-water portion (4W) while the suction port (10) is located in the other one of the deposition portion (4A) and the clear-water portion (4W).

According to one mode of the present invention, the previously described method for supplying processing water is further characterized in that the area of the opening (9) is larger than the cross-sectional area of the delivery pipe (14 or 15).

Another aspect of the present invention provides a method for supplying processing water (3) in the operation of processing a target object with a highly pressurized jet of processing water (3) containing an abrasive, wherein the method includes the following steps: supplying the processing water (3) into a tank (2 or 11) having a lower portion substantially tapering downwards; stratifying the processing water (3) in the tank (2 or 11) into a deposition portion (4A), which is a portion where the abrasive is deposited, and a clear-water portion (4W), which is a portion other than the deposition portion (4A) and formed by clear water substantially free from the abrasive; and pressurizing or suctioning the processing water (3) so as to deliver the processing water (3) through a delivery pipe (16 or 19) having an end located within the tank (2 or 11). The delivery pipe (16 or 19) has an opening (17 or 20) formed by cutting out a section that minimally corresponds to a portion of the side surface of the delivery pipe (16 or 19). The opening (17 or 20) extends over the deposition portion (4A) and the clear-water portion (4W).

According to one mode of the present invention, any of the previously described methods for supplying processing water (3) further includes the following steps: sending the processing water (3) being supplied into the tank (2 or 11) to a sieve mechanism (21), and preventing the clogging of the sieve mechanism (21). The step of preventing the clogging of the sieve mechanism (21) includes at least either a step of shaking the sieve mechanism (21) or steps of generating bubbles (25) and projecting the bubbles at the sieve mechanism (21).

### EFFECTS OF THE INVENTION

The effect of one aspect of the present invention is as follows. Firstly, the processing water (3) containing an abrasive is stored in the tank (2 or 11) having a lower portion substantially tapering downwards. Therefore, the abrasive can be deposited in a stable manner within the deposition portion (4A) located in the inner bottom portion of the tank (2 or 11). Secondly, the opening (9) is located near an end of the delivery pipe (8, 12, 14, 15 or 23) and at a position within either one of the deposition portion (4A) or the clear-water portion (4W), and the suction port (10) is located at a position within the other one of the deposition portion (4A) and the clear-water portion (4W). As a result, the clear water is suctioned through either one of the opening (9) or the suction port (10) while the abrasive in the deposition port (4A) is suctioned through the other one. Thus, the clogging of the delivery pipe (8, 12, 14, 15 or 23) with the abrasive is prevented.

Furthermore, in one mode of the present invention, the area of the opening (9) is larger than the cross-sectional area of the delivery pipe (14 or 15). This design impedes the clogging of the opening (9) with the abrasive in the deposition portion (4A) or enables a large amount of clear water to be suctioned through the opening (9) in the clear-water portion (4W). Thus, the clogging of the delivery pipe (14 or 15) with the abrasive is prevented.

The effect of another aspect of the present invention is as follows. Firstly, the processing water (3) containing an abrasive is stored in the tank (2 or 11) having a lower portion substantially tapering downwards. Therefore, the abrasive can be deposited in a stable manner within the deposition portion (4A) located in the inner bottom portion of the tank (2 or 11). Secondly, the opening (17 or 20), which is formed by cutting out a section that minimally corresponds to a portion of the side surface of the delivery pipe (16 or 19), is open to both the deposition portion (4A) and the clear-water portion (4W). As a result, both the clear water and the abrasive in the deposition portion (4A) are suctioned through the same opening (17 or 20). Thus, the clogging of the delivery pipe (16 or 19) with the abrasive is prevented.

Furthermore, in one mode of the present invention, the clogging prevention mechanism (22, 24) is provided for the sieve mechanism (21) located under the delivery pipe (5). The clogging prevention mechanism (22 or 24) includes at least either a shaking mechanism (22) for shaking the sieve mechanism (21) or a bubble generation mechanism (24), located in the vicinity of the sieve mechanism (21), for generating bubbles (25) and for projecting the bubbles at the sieve mechanism (21). Thus, the clogging of the sieve mechanism (21) is prevented.

Additionally, according to the present invention, it is possible to suction the water and abrasive at a stable ratio by appropriately setting the areas of the opening (9) and suction port (10) and the pressure for pushing or suctioning the processing water (3). In the case of the opening (17 or 20) formed by cutting out a section that minimally corresponds to a portion of the side surface of the delivery pipe (16 or 19), it is possible to suction the water and abrasive at a stable ratio by appropriately setting the position and area of the opening (17 or 20) and the pressure for pushing or suctioning the processing water (3). Thus, processing water (3) with a stable water-to-abrasive ratio is supplied from the tank (2 or 11) through the delivery pipe (8, 12, 14, 15, 16, 19 or 23) to the next component (e.g. a nozzle). Since it is unnecessary to agitate the processing water (3) stored in the tank (2 or 11), the structure of this system (1A-1E) for supplying processing water (3) can be simplified.

### BRIEF DESCRIPTION OF THE DRAWINGS

FIG. 1(1) is a pipeline diagram schematically showing the configuration of a system for supplying processing water according to the first embodiment of the present invention, and FIG. 1(2) is a pipeline diagram schematically showing the configuration of a system for supplying processing water according to a variation of the first embodiment.

FIG. 2 is a pipeline diagram schematically showing the configuration of a system for supplying processing water according to the second embodiment of the present invention.

FIGS. 3(1) and 3(2) are sectional views each showing an end of the delivery pipe used in a system for supplying processing water according to the third embodiment of the present invention.

FIGS. 4(1) and 4(2) are a sectional view and perspective view each showing an end of the delivery pipe used in a system for supplying processing water according to the fourth embodiment of the present invention.

FIG. 5(1) is a pipeline diagram schematically showing one configuration of the system for supplying processing water according to the fifth embodiment of the present invention, and FIG. 5(2) is a pipeline diagram schematically showing another configuration of the system for supplying processing water according to the present embodiment.

### EXPLANATION OF NUMERALS

1A, 1B, 1C, 1D, 1E . . . System for Supplying Processing Water
2, 11 . . . Tapered Tank
3 . . . Processing Water
4A . . . Deposition Portion
4W . . . Clear-Water Portion
5 . . . SupplyPipe
6 . . . Pressure Pipe
7 . . . High-Pressure Pump
8, 12, 14, 15, 16, 19, 23 . . . Delivery Pipe
9, 17, 20 . . . Opening
10 . . . Suction Port
13 . . . Bend
18 . . . Pressing Member
21 . . . Sieve Mechanism
22 . . . Shaking Mechanism (Clogging Prevention Mechanism)
24 . . . Bubble Generation Pipe (Clogging Prevention Mechanism, Bubble Generation Mechanism)
25 . . . Bubbles

### BEST MODE FOR CARRYING OUT THE INVENTION

The best mode for carrying out the present invention is a system (1A) for supplying processing water (3), which is used in the operation of processing a target object with a highly pressurized jet of processing water (3) containing an abrasive, wherein the system includes: a tank (2) for storing the processing water (3), having a lower portion substantially tapering downwards; a supply pipe (5) for supplying the processing water (3) to the tank (2); a delivery pipe (8) having an opening (9) located inside the tank (2); a pressure mechanism (7) located outside the tank (2), for pressurizing the processing water (3); and a suction port (10) provided in the side surface of the delivery pipe (8). The processing water (3) in the tank (2) is stratified into a deposition portion (4A), which is a portion where the abrasive is deposited, and a clear-water portion (4W), which is a portion other than the deposition portion (4A) and formed by clear water substantially free from the abrasive. The opening (9) is located near an end of the delivery pipe (8) and at a position within the deposition portion (4A), while the suction port (10) is located at a position within the clear-water portion (4W).

### FIRST EMBODIMENT

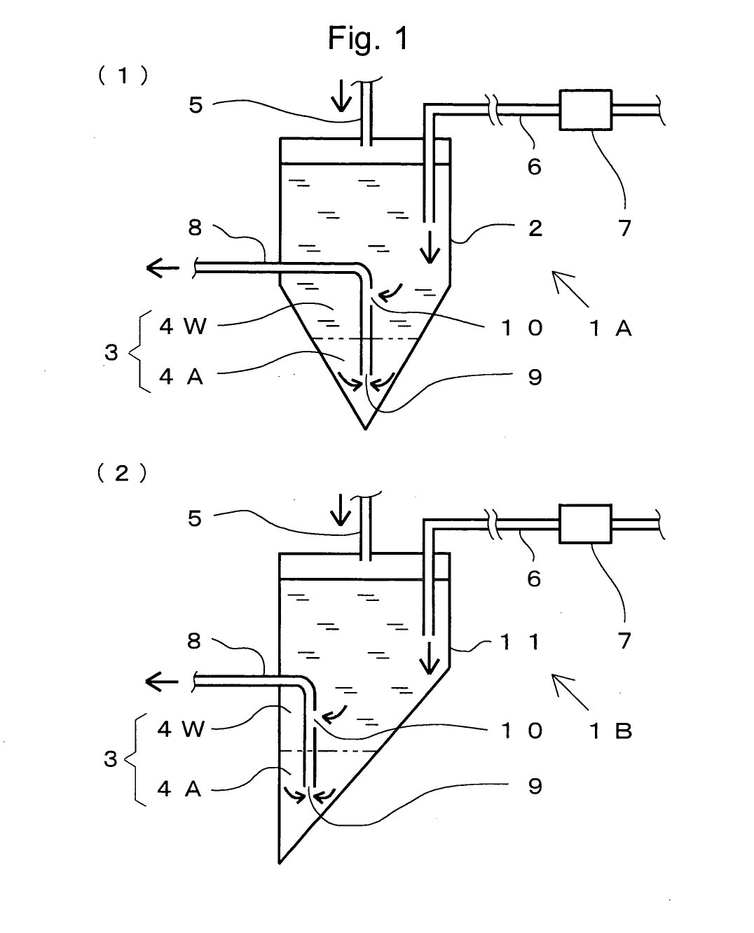

The first embodiment of the system for supplying processing water according to the present invention is hereinafter described with reference to FIG. 1. FIG. 1(1) is a pipeline diagram schematically showing the configuration of a system for supplying processing water according to the first embodiment, and FIG. 1(2) is a pipeline diagram schematically showing the configuration of a system for supplying processing water according to a variation of the first embodiment. For the purpose of simplicity, some components are appropriately omitted or depicted in an exaggeratedly schematic form in any of the figures used in the following description.

As shown in FIG. 1(1), the system 1A for supplying processing water according to the present embodiment includes a tapered tank 2 with its lower portion shaped like a cone pointing downwards. In this tapered tank 2, processing water 3 containing an abrasive is stored. The “tapered tank 2” in this description means any tank having a lower portion whose horizontal sectional area substantially decreases as the vertical position goes downwards. For example, the tapered tank 2 may be a tank in which the inner wall surfaces facing each other at a vertical section are partially parallel to each other, or a tank in which the inner wall surfaces facing each other at a vertical section has a portion where their distance increases as the vertical position goes downwards.

In this tapered tank 2, the processing water 3 is stratified into a deposition portion 4A, which is a portion where the abrasive is deposited, and a clear-water portion 4W, which is a portion other than the deposition portion 4A and formed by clear water substantially free from the abrasive. The “clear-water portion, which is a portion other than the deposition portion 4A and formed by clear water substantially free from the abrasive” means “a portion that consists of a large amount of clear water which may contain a small amount of water yet has a fluidity comparable to that of clear water that is perfectly free from the abrasive.” The two-dot chain line in the drawing is a virtual line showing the interfacial surface between the deposition portion 4A and the clear-water portion 4W.

A supply pipe 5 for supplying the processing water containing the abrasive into the tapered tank 2 is connected to the upper portion of the tapered tank 2. Also connected to this tank 2 is a pressure pipe 6. The pressure pipe 6 is arranged so that its outlet end is located within the clear-water portion 4W. The other end of the pressure pipe 6 is connected to a high-pressure pump 7. When this pump 7 is energized, high-pressure water is delivered through the pressure pipe 6 and a valve (not shown) into the tapered tank 2, whereby the clear-water portion 4W is pressurized.

The tapered tank 2 also has a delivery pipe 8 attached thereto. The delivery pipe 8 is arranged so that its opening 9 at the inlet end is located within the deposition portion 4A. The delivery pipe 8 is also arranged so that a suction port 10, which is formed in the side surface of the same pipe 8, is located within the clear-water portion 4W. The delivery pipe 8 leads to a nozzle (not shown) outside the tapered tank 2 (or on the left side in FIG. 1).

An operation of the system 1A for supplying processing water shown in FIG. 1(1) is hereinafter described. Initially, processing water 3 containing an abrasive is supplied through the supply pipe 5 into the tapered tank 2 and left intact for an adequate period of time. As a result, the abrasive sediments (deposits) within the tapered tank 2, forming the deposition portion 4A and the clear-water portion 4W.

Next, high-pressure water is delivered from the high-pressure pump 7 to pressurize the clear-water portion 4W inside the tapered tank 2. As a result, the following two phenomena take place. Firstly, within the clear-water portion 4W thus pressurized, the clear water is suctioned through the suction port 10 into the delivery pipe 8. Secondly, the pressure is transmitted through the pressurized clear-water portion 4W to the deposition portion 4A, in which the abrasive is suctioned through the opening 9 into the delivery pipe 8. In this process, the abrasive is directly suctioned from the deposition portion 4A into the delivery pipe 8. Such an abrasive is hard to flow although it is soaked with moisture.

The preceding descriptions concerning the present embodiment demonstrate that the following actions and effects are confirmed in the present embodiment. Firstly, clear water is suctioned into the delivery pipe 8 through the suction port 10 located higher than the opening 9 (in the direction in which the abrasive is to be delivered, namely, in the forward direction). This causes the hard-to-flow abrasive to be suctioned upwards (or forwards) and mixed with the clear water. Mixing the abrasive with the clear water in the manner makes the processing water 3 easy to flow. Thus, the clogging of the delivery pipe 8 with the abrasive is prevented.

Secondly, according to the present invention, the delivery pipe 8 is arranged so the opening 9 is located within the deposition portion 4A and the suction port 10 within the clear-water portion 4W. This arrangement makes it possible to suction the water and abrasive at a stable ratio by appropriately setting the areas of the opening 9 and suction port 10 and the pressure for pushing or suctioning the processing water 3. Thus, the processing water 3 containing the abrasive at a stable ratio can be supplied to the next component (e.g. a nozzle).

A variation of the first embodiment is hereinafter described with reference to FIG. 1(2). As shown in FIG. 1(2), the tapered tank 11 in the system 1B for supplying processing water according to the present embodiment has a lower portion with a vertical sectional shape in which one inner wall surface is flat while the opposite inner wall surface is inclined. In other words, rather than being cone-shaped, the lower portion of the tapered tank 11 is shaped like a triangular pole laid down with one side edge directed downwards.

In the system 1B for supplying processing water according to the present embodiment, the opening 9 at the end of the delivery pipe 8 is located within the deposition portion 4A while the suction port 10 formed in the side surface of the delivery pipe 8 is located within the clear-water portion 4W. Thus, as in the case of the system 1A for supplying processing water shown in FIG. 1(1), the clogging of the delivery pipe 8 with the abrasive is prevented in the system 1B.

In the system 1A shown in FIG. 1(1), the lower portion of the tapered tank 2 was shaped like a downward-pointing cone. The shape of the lower portion of the tapered tank 2 is not limited thereto and may be a rectangular pyramid, polygonal pyramid (having a polygonal cross section with five or more sides), tetrahedron or similar shape with the vertex pointing downwards. The lower portion of the tapered tank 11 may be shaped like a triangular pole whose sectional shape is identical to that of the lower portion of the tapered tank 2 shown in FIG. 1(1).

The vertical sectional shape of the lower portion of the tapered tank does not necessarily have its lower end sharply pointed; for example, the lower end may be trapezoidal or arched. The essential point is that the tapered tank should be appropriately shaped so that the abrasive will deposit in a stable manner within the lower portion of the tank.

The opening 9 in the previous embodiments was formed at the end (or end face) of the delivery pipe 8. However, this is not the only option. For example, the opening 9 may be formed in the side surface near the end face and at a position within the deposition portion 4A, but not at the end face. It is also possible that the opening 9 extends over the end face and a portion of the side surface near the end face. It is also possible to provide more than one opening 9. In summary, what is required is that one or more openings 9 are provided at positions that will be assuredly located within the deposition portion 4A.

The suction port 10 in the previous embodiments consisted of a single port formed in the delivery pipe 8. However, this is not the only option. For example, it is possible to provide two or more suction ports 10 at positions that will be assuredly located within the clear-water portion 4W.

### SECOND EMBODIMENT

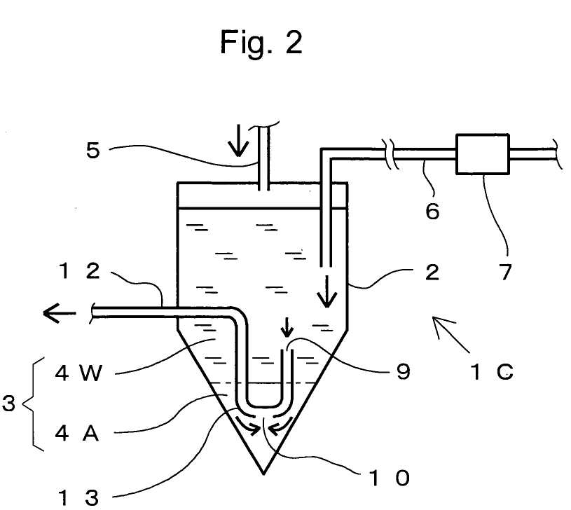

The second embodiment of the system for supplying processing water according to the present invention is hereinafter described with reference to FIG. 2. FIG. 2 is a pipeline diagram schematically showing the configuration of the system for supplying processing water according to the present embodiment. In any of the drawings used in the following descriptions, the components identical to those shown in FIG. 1 are denoted by the same numerals, and the explanations of those components will be omitted.

The system 1C for supplying processing water shown in FIG. 2 is characterized by the shape of the delivery pipe 12, which has a U-shaped bend 13 located inside the tapered tank 2. The opening 9 is formed at the inlet end of the bend 13 (i.e. the upper right end of the U shape), and the suction port 10 is formed in the lower portion of the bend 13. The delivery pipe 12 is arranged so that the opening 9 is located within the clear-water portion 9 and the suction port 10 within the deposition portion 4A.

An operation characteristic of the system 1C for supplying processing water shown in FIG. 2 is hereinafter described. In this system 1C, high-pressure water initially is delivered from the high-pressure pump 7 to pressurize the clear-water portion 4W inside the tapered tank 2. As a result, the following two phenomena take place. Firstly, within the clear-water portion 4W thus pressurized, the clear water is suctioned through the opening 9 into the delivery pipe 12. Secondly, the pressure is transmitted through the pressurized clear-water portion 4W to the deposition portion 4A, in which the abrasive is suctioned through the suction port 10 into the delivery pipe 12. The hard-to-flow abrasive thus suctioned is pushed by the pressurized clear water. Thus, the abrasive and clear water, being mixed together, flow in the upper left direction in the drawing (or in the forward direction for the abrasive). Mixing the abrasive with the clear water in the manner makes the processing water 3 easy to flow. Thus, the clogging of the delivery pipe 12 with the abrasive is prevented.

### THIRD EMBODIMENT

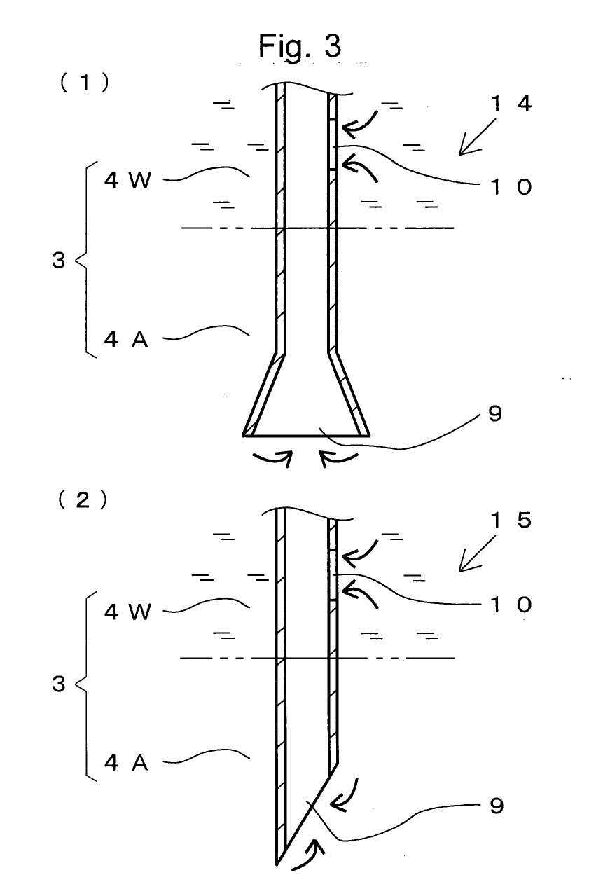

The third embodiment of the system for supplying processing water according to the present invention is hereinafter described with reference to FIG. 3. FIGS. 3(1) and 3(2) are sectional views each showing an end of the delivery pipe used in the system for supplying processing water according to the present embodiment. These delivery pipes are characterized in that the area of the opening formed at the end is larger than the cross sectional area of the delivery pipe.

The end of the delivery pipe 14 shown in FIG. 3(1) is shaped like an inverted funnel. The end of the delivery pipe 15 shown in FIG. 3(2) is shaped like an obliquely cut pipe. The opening 9 at the delivery pipe 15 is created by cutting off a portion corresponding to the side surface of the delivery pipe 15 (i.e. a portion that was originally a part of the side surface of the delivery pipe 15).

As is evident from FIG. 3(1), the area of the opening 9 at the end of the delivery pipe 14 is larger than the sectional area of the delivery pipe 14. Similarly, the area of the opening 9 at the end of the delivery pipe 15 in FIG. 3(2) is larger than the sectional area of the delivery pipe 15. Replacing the delivery pipe 8 in the system 1A or 1B shown in FIG. 1 with the delivery pipe 14 or 15 makes the opening 9 less likely to be clogged with the abrasive within the deposition portion 4A. Replacing the delivery pipe 12 in the system 1C shown in FIG. 2 with the delivery pipe 14 or 15 enables the clear water within the clear-water portion 4W to be suctioned through the opening 9 by a larger amount. Thus, the clogging of the delivery pipe 14 or 15 with the abrasive is prevented.

### FOURTH EMBODIMENT

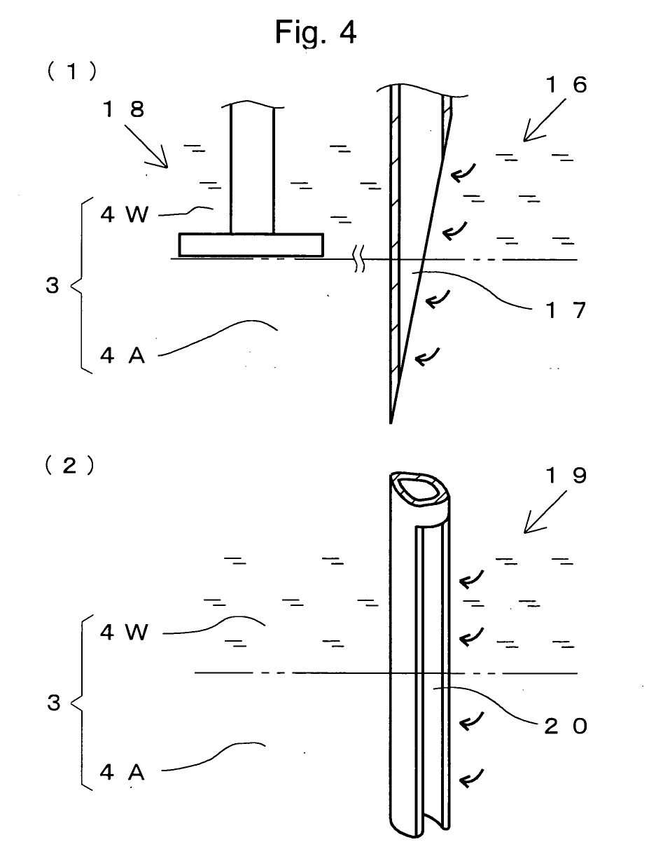

The fourth embodiment of the system for supplying processing water according to the present invention is hereinafter described with reference to FIG. 4. FIGS. 4(1) and 4(2) are a sectional view and perspective view each showing an end of the delivery pipe used in a system for supplying processing water according to the present embodiment.

The opening 17 at the end of the delivery pipe 16 shown in FIG. 4(1) is shaped like an obliquely cut pipe, similar to the one shown in FIG. 3(2). The opening 17 extends over both the deposition portion 4A and the clear-water portion 4W. As a result, both the clear water in the clear-water portion 4W and the abrasive in the deposition portion 4A are simultaneously suctioned through the opening 17. Thus, the clogging of the delivery pipe 16 with the abrasive is prevented.

As an additional matter of fact, as shown in FIG. 4(1), it is possible to press the deposition portion 4A with a pressing plate 18 consisting of a rod and plate. Combining this pressing plate 18 with an appropriate sensor makes it possible to detect the vertical position of the interfacial surface between the deposition portion 4A and the clear-water portion 4W (i.e. the position indicated by the two-dot chain line in the figure). Detecting the position of the interfacial surface opens up the following possibilities. Firstly, it will be possible to determine whether it is necessary to supply an abrasive and, if necessary, determine the amount of the abrasive to be supplied. Secondly, it will be possible to attach an actuator (not shown) to the delivery pipe 16 and control the vertical position of the delivery pipe 16 through the actuator so that the interfacial surface between the deposition portion 4A and the clear-water portion 4W will be maintained at a constant level in the opening 17.

The opening 20 of the delivery pipe 19 shown in FIG. 4(2) is formed by cutting off a portion corresponding to the side surface of the delivery pipe 19 (i.e. a portion that was originally a part of the side surface of the delivery pipe 19) along the length of the delivery pipe 19. As in the case of FIG. 4(1), the opening 20 extends over both the deposition portion 4A and the clear-water portion 4W. As a result, both the clear water in the clear-water portion 4W and the abrasive in the deposition portion 4A are simultaneously suctioned through the opening 20. Thus, the clogging of the delivery pipe 19 with the abrasive is prevented.

According to the present embodiment, it is possible to suction the water and abrasive at a stable ratio by appropriately setting the position and area of the opening 17 or 20 formed by cutting off a portion corresponding to the side surface of the delivery pipe 16 or 19, and the pressure for pushing or suctioning the processing water 3. The ratio between the water and the abrasive can be further stabilized by performing a control for maintaining the interfacial surface between the deposition portion 4A and the clear-water portion 4W at a constant level in the opening 17 or 20. Thus, the processing water 3 containing the abrasive at a stable ratio can be supplied to the next component (e.g. a nozzle).

### FIFTH EMBODIMENT

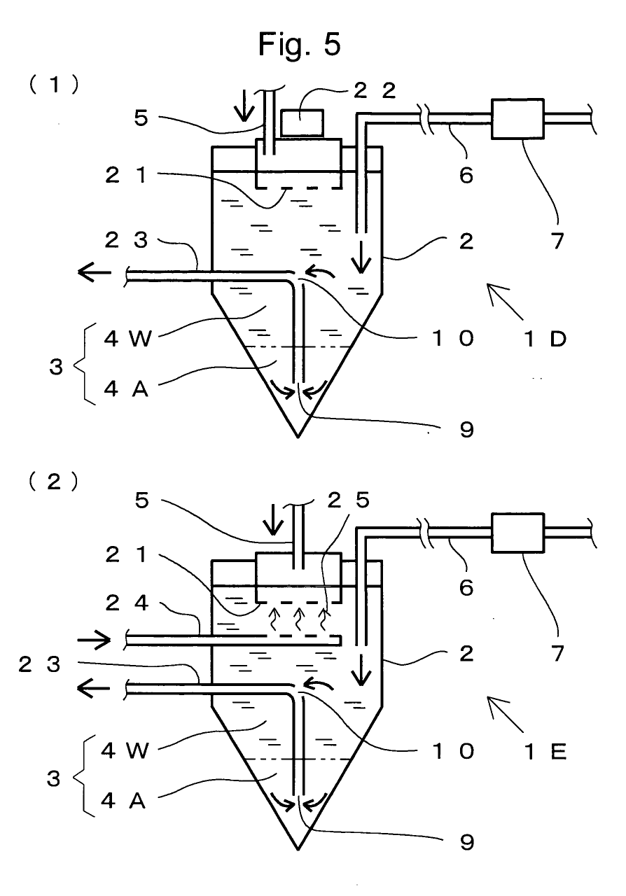

The fifth embodiment of the system for supplying processing water according to the present invention is hereinafter described with reference to FIG. 5. FIG. 5(1) is a pipeline diagram schematically showing one configuration of the system for supplying processing water according to the present embodiment, and FIG. 5(2) is a pipeline diagram schematically showing another configuration of the system for supplying processing water according to the present embodiment.

The system 1D for supplying processing water shown in FIG. 5(1) includes a sieve mechanism (filter) 21 provided under the supply pipe 5 for the purpose of removing an agglomerated abrasive, chip or other substances exceeding a specific size, and a shaking mechanism (e.g. a vibrator) 22 attached to the top of the sieve mechanism 21. This system can apply an appropriate degree of oscillation to the sieve mechanism 21. Oscillating the sieve mechanism 21 in this manner prevents the clogging of the sieve mechanism 21 with the abrasive or other substances. Additionally, in the delivery pipe 23 in the system 1D for supplying processing water, the suction port 10 is located at a curved portion of the delivery pipe 23. This design prevents the inner wall at the curved portion of the delivery pipe 23 from being abraded by the abrasive.

The system 1E for supplying processing water shown in FIG. 5(2) includes a sieve mechanism (filter) 21 provided under the supply pipe 5 and a bubble generation pipe 24 located in the vicinity of (and preferably under) the sieve mechanism 21. Upon receiving an injection of compressed air or similar high-pressure gas, the bubble generation pipe 24 generates a large number of small bubbles 25 and projects the bubbles 25 at the sieve mechanism 21. When colliding with the sieve mechanism 21, the bubbles 25 cause the sieve mechanism 21 to oscillate. Oscillating the sieve mechanism 21 in this manner prevents the clogging of the sieve mechanism 21 with the abrasive or other substances.

In the configuration shown in FIG. 5(2), an ultrasonic generation mechanism may be provided in place of the bubble generation pipe 24 in the vicinity of the sieve mechanism 21. In this case, the oscillation of the sieve mechanism 21 is achieved by both the collision of the bubbles 25, generated by ultrasonic vibration, with the sieve mechanism 21 and the burst of the generated bubbles 25. Thus, this configuration can also prevent the clogging of the sieve mechanism 21 with the abrasive or other substances. It is possible to combine the shaking mechanism 22 with either the bubble generation pipe 24 or the supersonic generation mechanism.

It is preferable that the suction port 10 is provided at the curved portion of the delivery pipe 23, as shown in FIG. 5. Accordingly, the delivery pipe 8 shown in FIG. 1 may have the suction port 10 formed at the position shown in FIG. 5.

The preceding five embodiments respectively dealt with the system 1A-1E for supplying processing water including a tapered tank 2 or 11. The tapered tank 2 or 11 can be used as a recovery tank for recycling, a main tank for storing a processing liquid and delivering it to the nozzle, or any other tank for storing processing water 3 containing an abrasive.

Instead of pressurizing the clear-water portion 4W with the high-pressure pump 7, the system may supply high-pressure water into the delivery pipe (e.g. the delivery pipe 8 in FIG. 1) by means of a high-pressure pump 7 connected via a pressure pipe to the delivery pipe 8 at a position downstream from the suction port 10. This operation causes the water in the delivery pipe 8 to be suctioned from the portion on the downstream side of the suction port 10 in the delivery pipe 8. Then, if the system is configured as shown in FIG. 1 or 5, the abrasive in the deposition portion 4A is suctioned through the opening 9 and the clear water in the clear-water portion 4W is suctioned through the suction port 10. On the other hand, if the system is configured as shown in FIG. 2, the clear water in the clear-water portion 4W is suctioned through the opening 9 and the abrasive in the deposition portion 4A is suctioned through the suction port 10. Thus, in any of these cases, the clogging of the delivery pipe 8, 12 or 23 with the abrasive is prevented. As is evident from the previous explanation concerning the mode in which the high-pressure pump 7 is used, the “suctioning” action at the opening 9 and suction port 10 of the delivery pipe 8 is attributable to the following two actions: pressurizing the clear-water portion 4W, and suctioning the water in the delivery pipe 8.

The processing water 3 containing an abrasive may additionally contain another substance for some other purposes. Examples of such a substance include cleaning agents, cooling agents, and substances for reducing the processing resistance (e.g. synthetic oils).

Examples of the object to be processed in the case of a cutting or machining process include semiconductor substrates (e.g. silicon substrate), ceramics substrates, printed boards and other substrates. A resin-sealed unit consisting of chip-type electronic components mounted on a substrate and sealed with a resin can also be the target to be processed. Other examples of the object to be processed are metallic plates, resin plates, ceramics members, concrete-containing members, and road surfaces. In the case of a polishing process, the inner surface of a forming die can be the object to be processed.

It should be noted that the present invention is not limited to each of the previously described embodiments. The features described thus far can arbitrarily and appropriately be combined, changed or selected as needed without departing from the spirit and scope of the present invention.

What is claimed is:

1. A system for supplying processing water, which is used in an operation of processing a target object with a highly pressurized jet of processing water containing an abrasive, comprising:
a tank for storing the processing water, having a lower portion substantially tapering downwards;
a supply pipe for supplying the processing water to the tank;
a delivery pipe having an opening located inside the tank;
either a pressure mechanism located outside the tank, for pressurizing the processing water, or a suction mechanism located outside the tank, for suctioning the processing water through the delivery pipe; and
a suction port provided in a side surface of the delivery pipe,
wherein:
the processing water in the tank is stratified into a deposition portion, which is a portion where the abrasive is deposited, and a clear-water portion, which is a portion other than the deposition portion and formed by clear water substantially free from the abrasive;
the opening is located near an end of the delivery pipe and at a position within either one of the deposition portion or the clear-water portion; and
the suction port is located at a position within the other one of the deposition portion and the clear-water portion.

2. The system for supplying processing water according to claim 1, wherein an area of the opening is larger than a cross-sectional area of the delivery pipe.

3. A system for supplying processing water, which is used in an operation of processing a target object with a highly pressurized jet of processing water containing an abrasive, comprising:
a tank for storing the processing water, having a lower portion substantially tapering downwards;
a supply pipe for supplying the processing water to the tank;
a delivery pipe having an opening located inside the tank; and
either a pressure mechanism located outside the tank, for pressurizing the processing water, or a suction mechanism located outside the tank, for suctioning the processing water through the delivery pipe,
wherein:
the opening is formed by cutting out a section that minimally corresponds to a portion of a side surface of the delivery pipe;
the processing water in the tank is stratified into a deposition portion, which is a portion where the abrasive is deposited, and a clear-water portion, which is a portion other than the deposition portion and formed by clear water substantially free from the abrasive; and
the opening extends over the deposition portion and the clear-water portion.

4. The system for supplying processing water according to claim 1, further comprising:
a sieve mechanism located under the delivery pipe; and
a clogging prevention mechanism for preventing clogging of the sieve mechanism, wherein:
the clogging prevention mechanism includes at least either a shaking mechanism for shaking the sieve mechanism or a bubble generation mechanism, located in the vicinity of the sieve mechanism, for generating bubbles and for projecting the bubbles at the sieve mechanism.

5. The system for supplying processing water according to claim 2, further comprising:
a sieve mechanism located under the delivery pipe; and
a clogging prevention mechanism for preventing clogging of the sieve mechanism, wherein:
the clogging prevention mechanism includes at least either a shaking mechanism for shaking the sieve mechanism or a bubble generation mechanism, located in the vicinity of the sieve mechanism, for generating bubbles and for projecting the bubbles at the sieve mechanism.

6. The system for supplying processing water according to claim 3, further comprising:
a sieve mechanism located under the delivery pipe; and
a clogging prevention mechanism for preventing clogging of the sieve mechanism, wherein:
the clogging prevention mechanism includes at least either a shaking mechanism for shaking the sieve mechanism or a bubble generation mechanism, located in the vicinity of the sieve mechanism, for generating bubbles and for projecting the bubbles at the sieve mechanism.

7. A method for supplying processing water in an operation of processing a target object with a highly pressurized jet of processing water containing an abrasive, comprising the following steps:
supplying the processing water into a tank having a lower portion substantially tapering downwards;
stratifying the processing water in the tank into a deposition portion, which is a portion where the abrasive is deposited, and a clear-water portion, which is a portion other than the deposition portion and formed by clear water substantially free from the abrasive; and
pressurizing or suctioning the processing water so as to deliver the processing water through a delivery pipe having an end located within the tank,
wherein:
the delivery pipe has an opening provided near an end thereof and a suction port provided in a side surface thereof; and
in the step of delivering the processing water, the opening is located at a position within either one of the deposition portion or the clear-water portion while the suction port is located in the other one of the deposition portion and the clear-water portion.

8. The method for supplying processing water according to claim 7, wherein an area of the opening is larger than a cross-sectional area of the delivery pipe.

9. A method for supplying processing water in an operation of processing a target object with a highly pressurized jet of processing water containing an abrasive, comprising the following steps:
supplying the processing water into a tank having a lower portion substantially tapering downwards;
stratifying the processing water in the tank into a deposition portion, which is a portion where the abrasive is deposited, and a clear-water portion, which is a portion other than the deposition portion and formed by clear water substantially free from the abrasive; and
pressurizing or suctioning the processing water so as to deliver the processing water through a delivery pipe having an end located within the tank,
wherein:
the delivery pipe has an opening formed by cutting out a section that minimally corresponds to a portion of a side surface of the delivery pipe; and
the opening extends over the deposition portion and the clear-water portion.

10. The method for supplying processing water according to claim 7, further comprising the following steps:
sending the processing water being supplied into the tank to a sieve mechanism; and
preventing the clogging of the sieve mechanism,
wherein:
the step of preventing the clogging of the sieve mechanism includes at least either a step of shaking the sieve mechanism or steps of generating bubbles and projecting the bubbles at the sieve mechanism.

11. The method for supplying processing water according to claim 8, further comprising the following steps:
sending the processing water being supplied into the tank to a sieve mechanism; and
preventing the clogging of the sieve mechanism,
wherein:
the step of preventing the clogging of the sieve mechanism includes at least either a step of shaking the sieve mechanism or steps of generating bubbles and projecting the bubbles at the sieve mechanism.

12. The method for supplying processing water according to claim 9, further comprising the following steps:
sending the processing water being supplied into the tank to a sieve mechanism; and
preventing the clogging of the sieve mechanism,
wherein:
the step of preventing the clogging of the sieve mechanism includes at least either a step of shaking the sieve mechanism or steps of generating bubbles and projecting the bubbles at the sieve mechanism.
